(19) United States
(12) Patent Application Publication
(10) Pub. No.: US 2014/0158913 A1
(43) Pub. Date: Jun. 12, 2014

(54) MICROPARTICLE ANALYSIS APPARATUS AND MICROPARTICLE ANALYSIS METHOD

(71) Applicant: Sony Corporation, Tokyo (JP)

(72) Inventor: Hironobu Tanase, Tokyo (JP)

(73) Assignee: Sony Corporation, Tokyo (JP)

(21) Appl. No.: 14/081,567

(22) Filed: Nov. 15, 2013

(30) Foreign Application Priority Data
Dec. 6, 2012 (JP) 2012-267648

(51) Int. Cl. G01N 21/64

(52) U.S. Cl. CPC G01N 21/6402
USPC 250/459.1; 356/300; 315/294; 250/216

(57) ABSTRACT

There is provided a microparticle analysis apparatus including a light irradiation unit, which includes a plurality of light sources that emit laser light beams having different wavelengths, and which is configured to irradiate, with the laser light, microparticles flowing through a channel, and a light source drive control unit configured to control light emission by each light source in the light irradiation unit. The light source drive control unit is configured to supply a first current to each light source, and to supply in a time-division manner a second current to each light source while the first current is being supplied.

### CROSS REFERENCE TO RELATED APPLICATIONS

This application claims the benefit of Japanese Priority Patent Application JP 2012-267648 filed Dec. 6, 2012, the entire contents of which are incorporated herein by reference.

### BACKGROUND

The present technology relates to a microparticle analysis apparatus and a microparticle analysis method for optically detecting a specimen such as a microparticle. More specifically, the present technology relates to a microparticle analysis apparatus and a microparticle analysis method in which a plurality of light sources are used.

An optical measurement method that uses a flow cytometry (a flow cytometer) is utilized to identify biologically-relevant microparticles, such as microbes, ribosomes and the like. Flow cytometry is an analytical technique for identifying individual microparticles from among a plurality of microparticles by irradiating, with laser light having a specific wavelength, microparticles flowing in a single line through a channel, and detecting fluorescence and scattered light emitted from the microparticles.

Further, recently, multicolor analysis for obtaining a plurality of information about each microparticle is also carried out by modifying the microparticles with a plurality of fluorochromes, and then separating and detecting the fluorescence emitted from the respective microparticles. Flow cytometers (e.g., refer to JP-A-2007-46947, JP-A-2009-270990, and JP-A-2010-286381) that are capable of irradiating, with a plurality of laser light beams having different wavelengths, microparticles flowing through a channel and detecting the fluorescence in a plurality of wavelengths that is emitted from the microparticles have been proposed in order to perform such multicolor analysis.

FIG. 16 is a diagram that schematically illustrates the configuration of a past flow cytometer that is described in JP-A-2007-46947. As illustrated in FIG. 16, a flow cytometer 101 described in JP-A-2007-46947 is mainly configured from a flow system 102, and optical system 103, and a signal processing apparatus 104. Further, cells 105 modified with a fluorochrome are arranged in a line in a flow cell of the flow system 102, and each cell 105 is irradiated with a plurality of laser light beams having different wavelengths by the optical system 103.

During this operation, a plurality of laser light beams having different wavelengths from each other are emitted from light sources 106a, 106b, and 106c that are included in a modulator at a predetermined period but at a different phase from each other. These plurality of light beams are guided along the same incident light path by a light guidance member 107, and are condensed on the cells 105. Further, the scattered light and fluorescence emitted from the cells 105 are separated into their respective wavelengths by a half mirror, a band-pass filter and the like, and detected by a respective PMT (photo-multiplier tube).

### SUMMARY

However, in past flow cytometers, since fluorescence from non-target fluorochromes leaks into each detector, in order to perform analysis accurately, fluorescence correction that subtracts the portion where fluorescence is overlapping is carried out. Although the problem of fluorescence leakage is eliminated by using pigments whose excitation spectrum does not overlap like in the measurement method of JP-A-2009-270990, the pigments that can be selected are limited.

On the other hand, although the flow cytometer described JP-A-2007-46947 emits a plurality of light beams at a predetermined period but at a different phase from each other, in this method, an emission delay phenomenon and relaxation oscillation after emission occur due to the repeated switching of each laser alternately on and off. For example, when light is repeatedly emitted and then extinguished at a frequency of several hundred MHz, the duration of the emission delay caused by this repeated emission and extinguishment reaches about several nanoseconds, which can prevent the laser from emitting light at the proper timing. Especially, when rapidly switching between on and off, wavelength control becomes very difficult. Further, if a laser relaxation oscillation phenomenon occurs, since the crest value is no longer constant, there is a possibility that a changed value may be detected. In such a case, the accuracy of the measurement value deteriorates.

According to an embodiment of the present disclosure, there are provided a microparticle analysis apparatus and a microparticle analysis method capable of accurately detecting fluorescence emitted from each pigment even when microparticles have been modified with a plurality of fluorochromes.

According to an embodiment of the present disclosure, there is provided a micro particle analysis apparatus including a light irradiation unit, which includes a plurality of light sources that emit laser light beams having different wavelengths, and which is configured to irradiate, with the laser light, microparticles flowing through a channel, and a light source drive control unit configured to control light emission by each light source in the light irradiation unit. The light source drive control unit is configured to supply a first current to each light source, and to supply in a time-division manner a second current to each light source while the first current is being supplied.

The first current may be set to be greater than the second current.

The light source drive control unit may include, for each light source, a first current control unit configured to control supply of the first current and a second current control unit configured to control supply of the second current.

The light source drive control unit may include, for each light source, an auto power control circuit and a drive circuit.

The microparticle analysis apparatus may further include a light detection unit configured to detect light emitted from microparticles irradiated with the laser light. The light detection unit may include at least a light separation optical system configured to separate light emitted from the microparticles according to wavelength, and a plurality of photodetectors configured to detect light separated by the light separation optical system.

The light detection unit may include, for each photodetector, a detection circuit configured to control acquisition of a detection signal.

The detection circuit may include a switch configured to switch between a correction mode and a measurement mode.

The microparticle analysis apparatus may further include a plurality of auto power control circuits provided in the light source drive control unit, and a timing generation circuit configured to output a timing signal to a plurality of detection circuits provided in the light detection unit.

According to an embodiment of the present disclosure, there is provided a microparticle analysis method including emitting laser light beams having different wavelengths from each other from a plurality of light sources, and irradiating, with each laser light beam, microparticles flowing through a channel. The microparticles are irradiated with the plurality of laser light beams having different wavelengths in a time division manner by supplying a first current to each light source, and supplying in a time-division manner a second current to each light source while the first current is being supplied.

The first current may be set to be greater than the second current.

Supply of the first current and supply of the second current may be controlled individually and independently.

The microparticle analysis method may further include separating the light emitted from the microparticles irradiated with laser light according to wavelength, and detecting the light separated in the light separation step with a plurality of photodetectors.

Emission by the light sources and detection by the photodetectors may be performed in synchronization.

Fluorescence data detected in the detection step may be corrected based on offset data detected in advance.

According to one or more of embodiments of the present disclosure, since interference among the detected light beams can be suppressed while preventing relaxation oscillation and emission delay, fluorescence emitted from each pigment can be accurately detected.

### BRIEF DESCRIPTION OF THE DRAWINGS

FIG. 1 is a block diagram illustrating a configuration of a microparticle analysis apparatus according to a first embodiment of the present disclosure;

FIG. 2 is an overall circuit diagram of the microparticle analysis apparatus illustrated in FIG. 1;

FIG. 3 is a block diagram illustrating a configuration of the APC circuits illustrated in FIG. 1;

FIG. 4 is a block diagram illustrating a configuration of the drive circuits illustrated in FIG. 1;

FIG. 5 is a circuit diagram illustrating the drive circuit illustrated in FIG. 4;

FIG. 6 is a block diagram illustrating a configuration of the detection circuits illustrated in FIG. 1;

FIG. 7 is a diagram illustrating a light emission pattern of respective light sources;

FIG. 8 is a diagram illustrating timing signal patterns;

FIG. 9 is a timing chart of a detection signal and a sample hold;

FIG. 10A is a fluorescence spectrum obtained by a microparticle analysis method according to an embodiment of the present disclosure, and FIG. 10B is a fluorescence spectrum obtained by a past method;

FIG. 11A is a diagram illustrating a laser emission waveform in a microparticle analysis apparatus according to a first embodiment of the present disclosure, and FIG. 11B is a diagram illustrating a laser emission waveform in a past apparatus;

FIG. 12 is a block diagram illustrating a configuration of a microparticle analysis apparatus according to a modified example of the first embodiment of the present disclosure;

FIG. 13 is a block diagram illustrating a configuration of a detection circuit in a microparticle analysis apparatus according to a second embodiment of the present disclosure;

FIG. 14A is a diagram illustrating a light source emission pattern during normal measurement, and FIG. 14B is a fluorescence spectrum at that time;

FIG. 15A is a diagram illustrating a light source emission state during correction value acquisition, and FIG. 15B is a fluorescence spectrum at that time; and

FIG. 16 is a diagram schematically illustrating a configuration of a past flow cytometer described in JP-A-2007-46947.

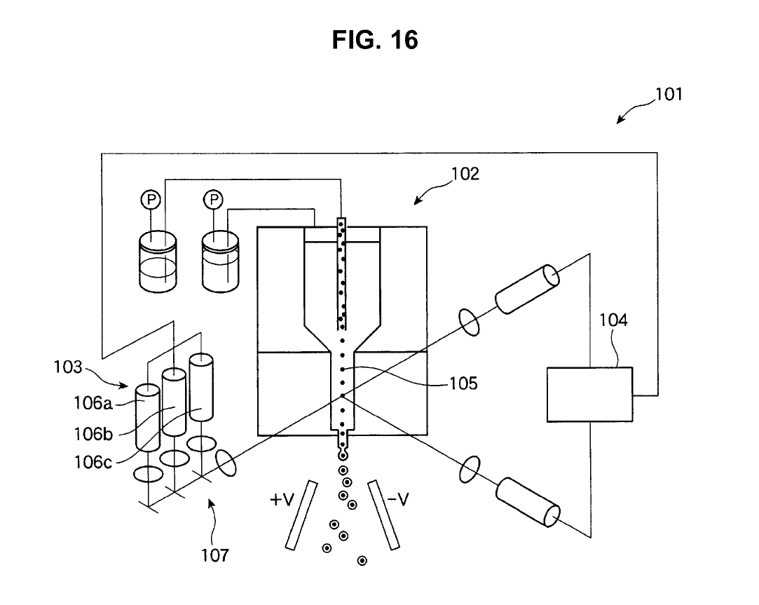

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. Further, the description will be carried out in the following order.

1. First embodiment of the present disclosure (Example of a microparticle analysis apparatus that performs irradiation of laser light in a time-division manner)
2. Modified example of the first embodiment of the present disclosure (Example of a microparticle analysis apparatus that includes a fluorescence objective lens unit)
3. Second embodiment of the present disclosure (Example of a microparticle analysis apparatus including a correction function)<

### 1. First Embodiment of the Present Disclosure

### Overall Configuration

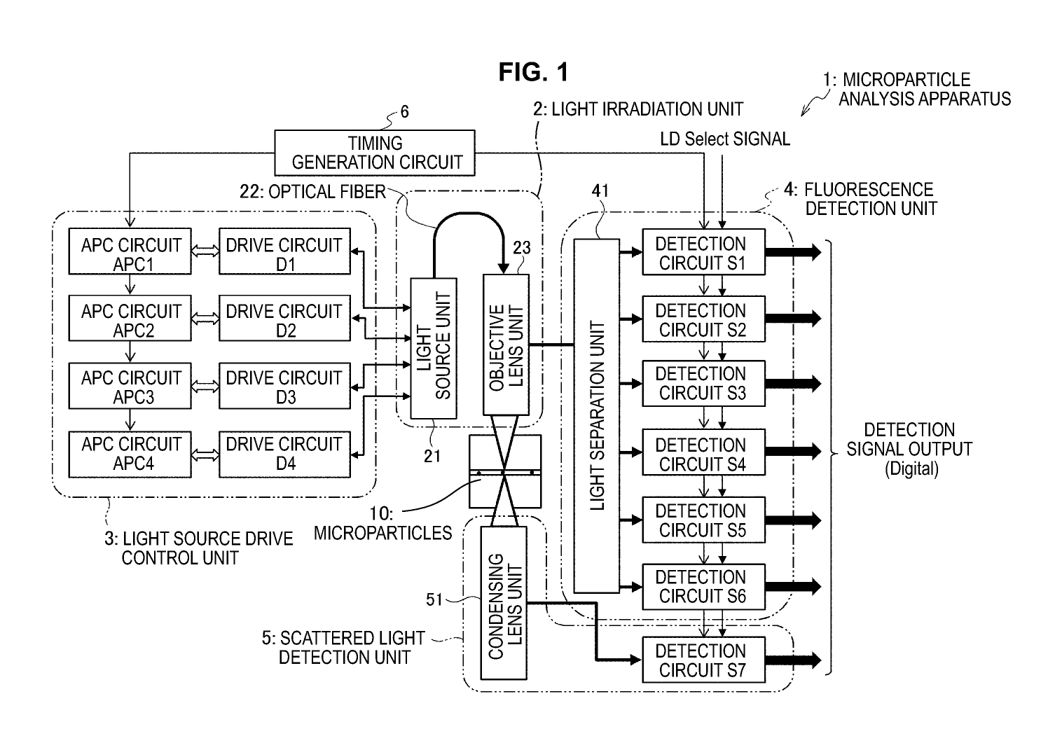

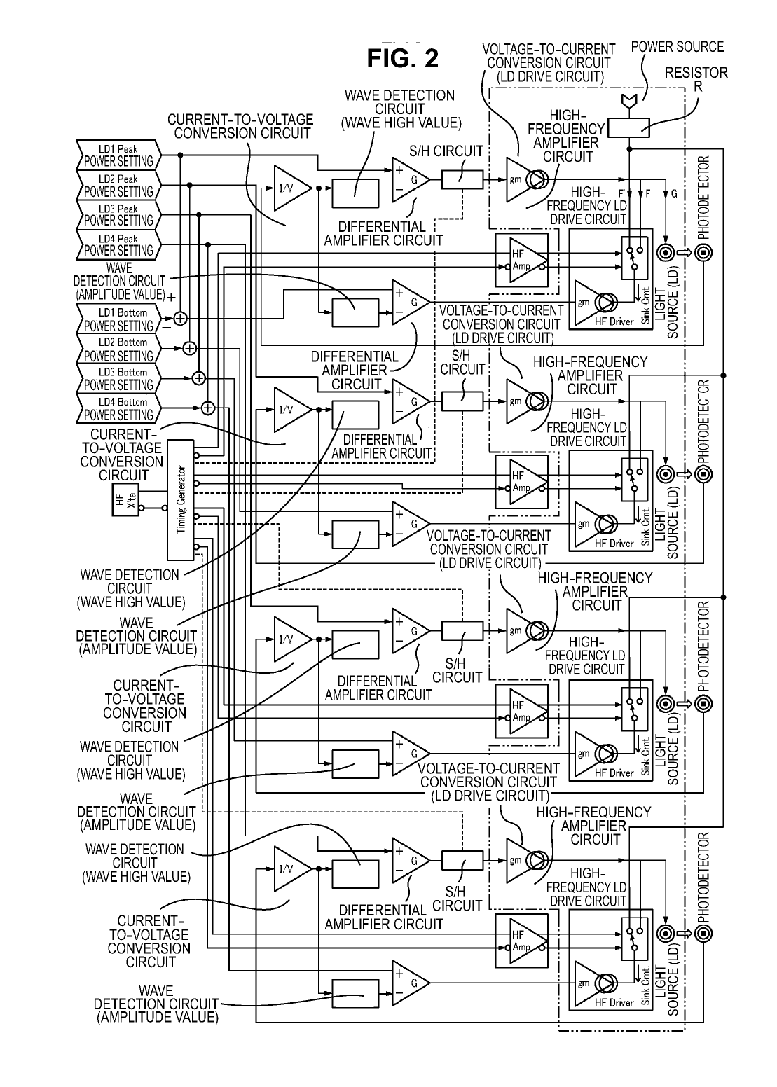

First, a microparticle analysis apparatus according to the first embodiment of the present disclosure will be described. FIG. 1 is a block diagram illustrating a configuration of the microparticle analysis apparatus according to the present embodiment. FIG. 2 is an overall circuit diagram of that microparticle analysis apparatus. As illustrated in FIG. 1, a microparticle analysis apparatus 1 according to the present embodiment is provided with a light irradiation unit 2 that irradiates, with laser light, microparticles 10 flowing in a single line through a sample channel, and a light source drive control unit 3 that controls the light emission by each light source in the light irradiation unit 2.

The microparticle analysis apparatus 1 includes a fluorescence detection unit 4 that detects fluorescence emitted from the microparticles 10 irradiated with laser light. Further, the microparticle analysis apparatus 1 may also optionally be provided with another light detection unit that detects non-fluorescent light, such as a scattered light detection unit 5 that detects scattered light.

### (Light Irradiation Unit 2)

The light irradiation unit 2 is provided with, for example, a light source unit 21 that generates laser light which acts as excitation light, and an objective lens unit 23 that condenses laser light generated by the light source unit 21 onto the microparticles 10. The light source unit 21 includes a plurality of light sources that generate laser light beams having different wavelengths from each other. The laser light emitted from each light source is condensed using a mirror, a lens or the like, and is guided to the objective lens unit 23 by a optical fiber 22.

### (Light Source Drive Control Unit 3)

The light source drive control unit 3 controls the light emission by each light source that is provided in the light source unit 21. The light source drive control unit 3 includes, for example, auto power control (APC) circuits APC1 to APC4 and drive circuits D1 to D4.

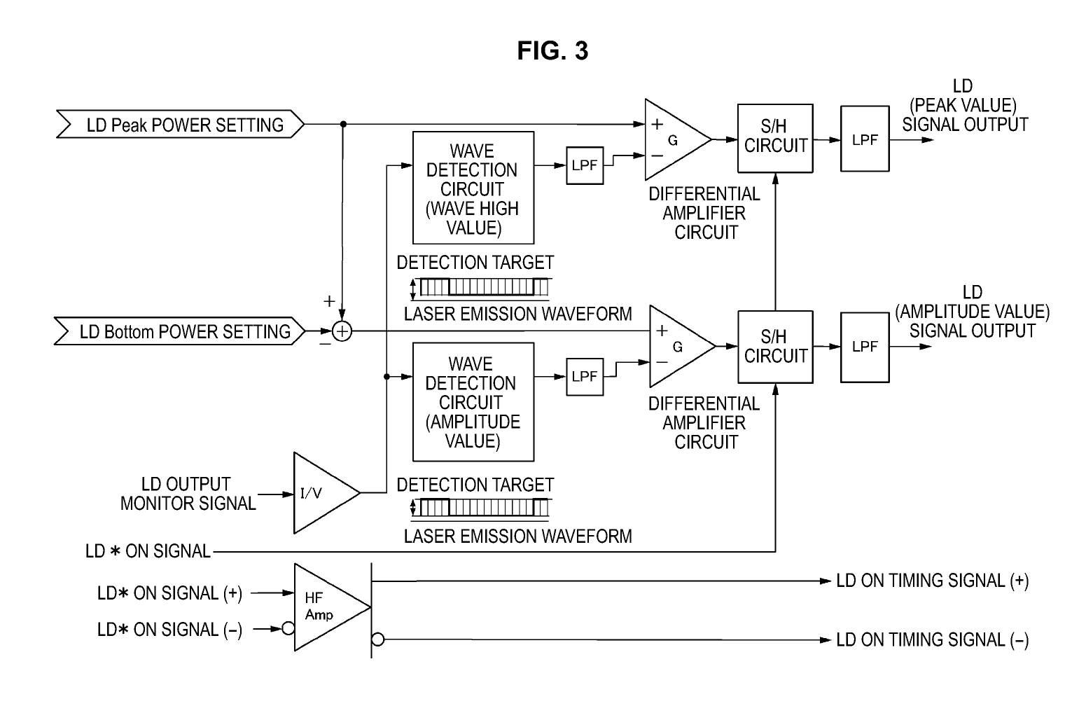

FIG. 3 is a block diagram illustrating the configuration of the APC circuits. As illustrated in FIG. 3, each of the APC circuits APC1 to APC4 are provided with, for a peak signal and an amplitude signal, respectively, a detection circuit, a differential amplifier circuit, a sample hold (S/H) circuit, and a low-pass filter (LPF) circuit. Further, each of the APC circuits APC1 to APC4 are configured so that a peak current and a bottom current can be independently controlled.

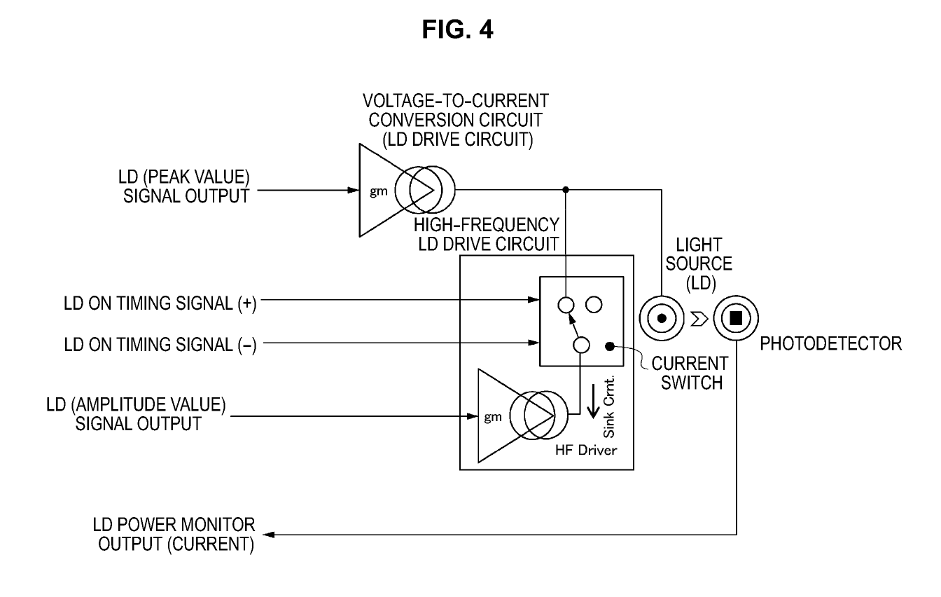

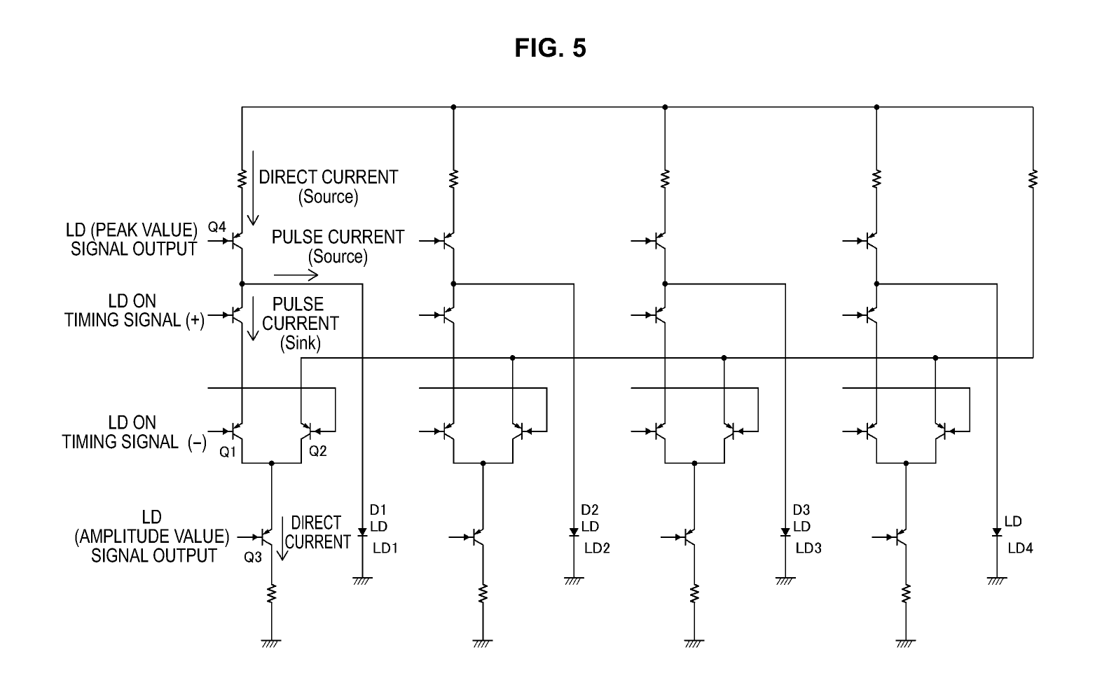

On the other hand, FIG. 4 is a block diagram illustrating the configuration of the drive circuits, and FIG. 5 is a circuit diagram. As illustrated in FIG. 4, each of the drive circuits D1 to D4 are provided with a voltage-to-current conversion circuit, a current switch, and a laser drive circuit. Further, as illustrated in FIG. 5, the current switch of the laser drive circuits is cascoded to one of the transistors of an emitter-coupled circuit, and the collector of the transistor Q4 is connected to the collector of that emitter-coupled circuit.

It is noted that although FIG. 1 illustrates a case in which four APC circuits and four drive circuits are provided, the present disclosure is not limited to this. The number of APC circuits and drive circuits may be appropriately changed based on the number of light sources.

### (Light Detection Unit)

The fluorescence detection unit 4 includes a light separation unit 41 that separates the fluorescence emitted from the microparticles 10 according to wavelength, a plurality of photodetectors (not illustrated) that detect the fluorescence separated by the light separation unit 41 and the like. This light separation unit 41 in the fluorescence detection unit 4 includes a wavelength filter, a mirror or the like, so that only a detection target wavelength is incident on the photodetectors.

On the other hand, the scattered light detection unit 5 includes a condensing lens unit 51 that condenses the scattered light emitted from the microparticles 10, a photodetector (not illustrated) that detects the condensed scattered light and the like. This condensing lens unit 51 in the scattered light detection unit 5, which is configured from a condensing lens, a mirror or the like, condenses the scattered light from the microparticles 10 onto the photodetector.

Here, the photodetectors provided in the fluorescence detection unit 4 and the scattered light detection unit 5 may be, for example, a CCD (charge-coupled device), a PMT (photo-multiplier tube) and the like.

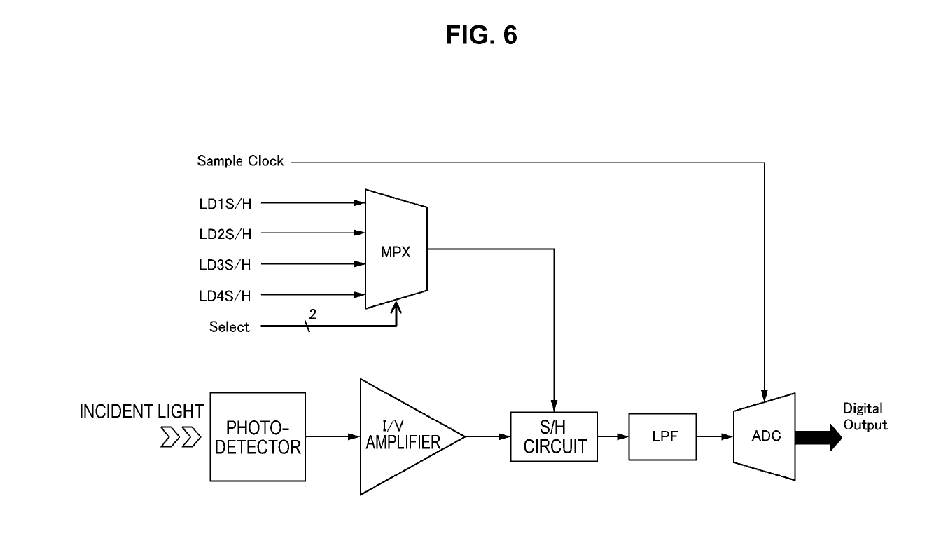

In addition, detection circuit S1 to S6 that control the acquisition of a detection signal by each detector are provided in the fluorescence detection unit 4 and the scattered light detection unit 5. FIG. 6 is a block diagram illustrating a configuration of the detection circuits. As illustrated in FIG. 6, in each of the detection circuits S1 to S6, a current-to-voltage conversion amplifier, a sample hold (S/H) circuit, a low-pass filter circuit, and an analog-digital conversion circuit (ADC) are arranged in that order.

Further, a switch (MPX) for selecting the fluorescence to be detected (the laser to output the excitation light) is connected to the sample hold (S/H) circuit, and a sample clock is input to the analog-digital conversion circuit (ADC). Further, in the microparticle analysis apparatus 1 according to the present embodiment, a light source selection signal can be controlled by an information processing apparatus and the like so that the combination of the fluorescent body to be detected and the detection circuit S1 to S6 channel that is used can be freely changed.

### (Timing Generation Circuit 6)

The microparticle analysis apparatus 1 according to the present embodiment may also include a timing generation circuit that outputs a timing signal to the APC circuits APC1 to APC4 provided in the light source drive control unit 3 and to the detection circuits S1 to S6 provided in the fluorescence detection unit 4.

There are two types of signals that are used for the timing, a signal that controls the ON/OFF of the light sources and a signal that controls the sample hold (S/H) circuits of the detection circuits S1 to S6. Accordingly, a timing signal for successively and intermittently turning on each of the light sources and a timing signal for acquiring a detection signal are generated by a timing generation circuit 6.

### (Operation)

Next, operation of the microparticle analysis apparatus 1, namely, a method for analyzing the microparticles 10 by using the microparticle analysis apparatus 1 according to the present embodiment, will be described. In the microparticle analysis method according to the present embodiment, laser light beams having different wavelengths from each other are emitted from a plurality of light sources, and microparticles flowing through a channel are irradaited with the respective laser light beams. During this operation, the microparticles 10 are irradiated with a plurality of laser light beams having different wavelengths in a time-division manner on by supplying a first current to each light source, and supplying in a time-division manner a second current to each light source while the first current is being supplied.

Here, examples of the “microparticles 10” that are measured in the microparticle analysis method according to the present embodiment may include cells, biologically-relevant microparticles such as microbes, ribosomes and the like, and artificial particles such as latex particles, gel particles, and industrial particles.

Further, the biologically-relevant microparticles may also be the chromosomes, ribosomes, mitochondria, organelles and the like that form various types of cell. In addition, examples of cells include plant cells, animal cells, hematopoietic cells and the like. Still further, examples of microbes include bacteria such as E. coli, viruses such as the tobacco mosaic virus, fungi such as yeast and the like. The term biologically-relevant microparticles also includes biologically-relevant polymers such as nucleic acids, proteins, and complexes thereof.

On the other hand, examples of industrial particles include particles formed from an organic polymeric material, an inorganic material, a metal material and the like. As an organic polymeric material, polystyrene, styrene-divinylbenzene, polymethyl methacrylate and the like may be used. As an inorganic material, glass, silica, magnetic materials and the like may be used. As a metal material, for example, a metal colloid, aluminum and the like can be used. It is noted that although the shape of these microparticles is usually spherical, these microparticles may have a non-spherical shape. Further, the size, mass and the like of these microparticles is also not especially limited.

In the microparticle analysis apparatus 1 according to the present embodiment, the emission timing of each light source is controlled by the timing generation circuit 6. Further, when the microparticles 10 flowing through the channel enter a laser light irradiation area, the wavelength of the laser light is changed due to diffusion of the light and the due to a fluorescent body. When a fluorescent body is irradiated with light in a specific wavelength, the fluorescent body emits light having a wavelength spectrum unique to the fluorescent body.

At this point, detection circuits S1 to S6 acquire a detection signal only when a specific light source is emitting light. When light from a non-detection target light source is emitted, the detection circuits S1 to S6 maintain the signal level that had previously been acquired. This signal is subjected to sampling frequency component removal by passing the signal through a low-pass filter (LPF) circuit, and then converted into digital data by an analog-digital conversion circuit.

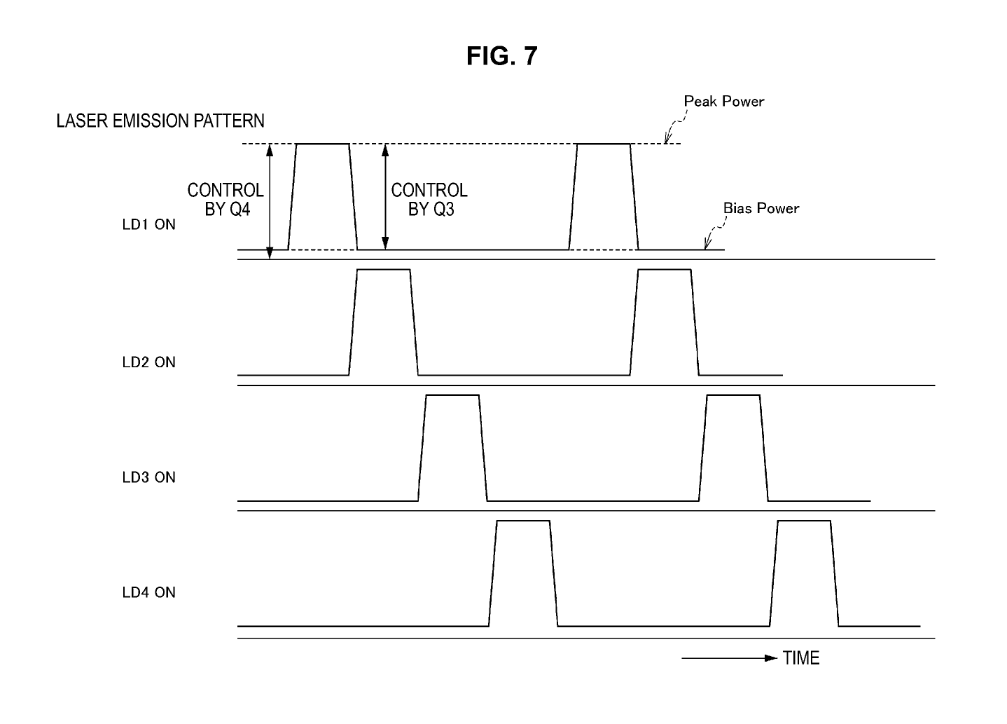

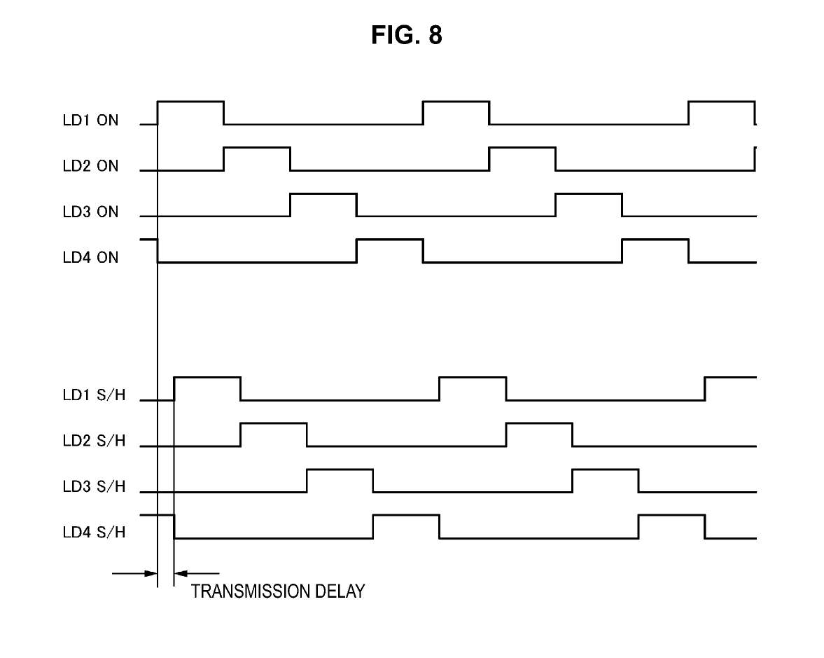

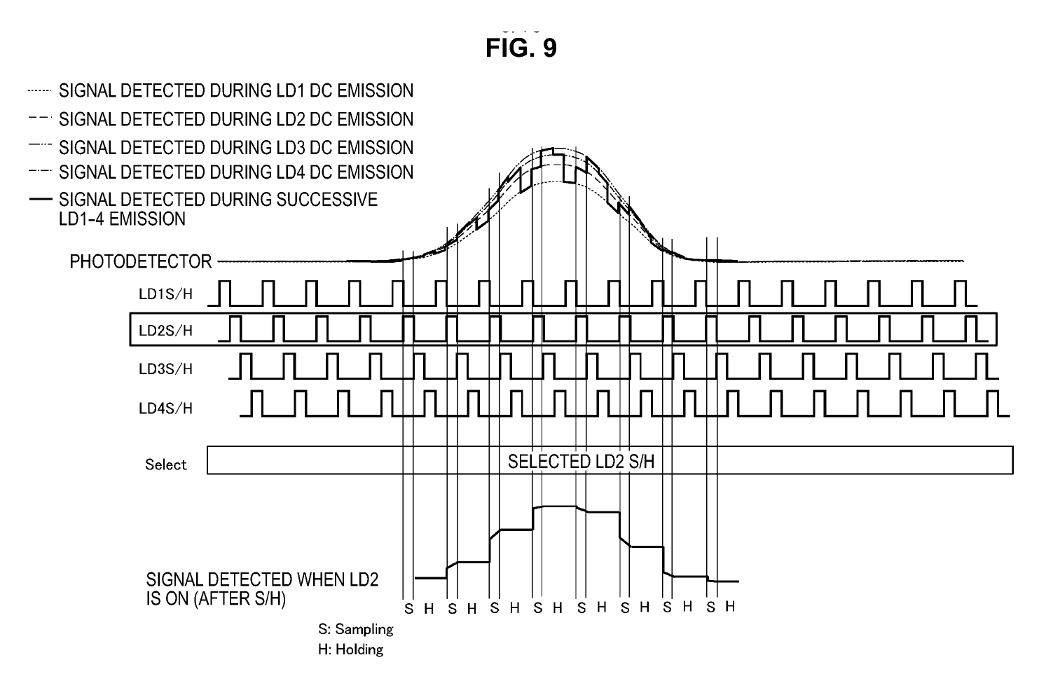

Operation of the various circuits provided in the microparticle analysis apparatus 1 according to the present embodiment will now be described. FIG. 7 is a diagram illustrating a light emission pattern of the respective light sources. FIG. 8 is a diagram illustrating timing signal patterns. Further, FIG. 9 is timing chart of a detection signal and a sample hold.

An electric signal (a minute current) photoelectrically converted by the photodetectors is input as a laser light output monitor signal to each of the APC circuits APC to APC 4 in the light source drive control unit 3. Further, this laser light output monitor signal is input to two wave detection circuits via the current-to-voltage conversion (I/V) amplifier.

At a peak value wave detection circuit, the peak value of the laser light output monior signal is detected. This peak value is compared by the differential amplifier circuit with a set peak value. The difference between the values is obtained and amplified by a very large gain (error signal amplification). At the differential amplifier circuit, the power of the light generated by the laser is controlled by amplifying a comparison signal between the set value and the detected light signal (laser light output monitor signal). Specifically, when the returned the laser light output monitor signal is greater than the set value, light output is decreased, and when the returned laser light output monitor signal is smaller than the set value, light output is increased.

Further, this amplified signal is temporarily input and held by the sample hold (S/H) circuit as the correct peak value. Then, the output of the sample hold (S/H) circuit is input to the gm amplifier (transistor Q4 of the drive circuit) to obtain a peak current.

On the other hand, at an amplitude detection circuit, an amplitude value of the laser light output monior signal is detected. At the differential amplifier circuit, the detected bottom voltage value is compared with the difference between the peak set value and the bottom set value, and the difference therebetween is taken as an error signal of the pulse amplitude value. Further, similar to the peak value, this amplitude value error signal is amplified by a very large gain (error signal amplification). This amplified signal is temporarily input and held by the sample hold (S/H) circuit as the correct amplitude value. Then, the output of the sample hold (S/H) circuit is input to the gm amplifier (transistor Q3 of the drive circuit) to obtain an amplification current.

The pulse current supplied to each light source is defined by a peak value and a bottom value. The peak current (first current) is controlled by a constant current source. The bottom current (second current) is supplied via the transistor Q3, and its value is controlled by the constant current source as the difference between the supplied direct current and the current of the transistor Q3. Consequently, relaxation oscillation and emission delay unique to the laser can be suppressed. Further, in the microparticle analysis method according to the present embodiment, since the peak current and the bottom current are individually controlled, temperature drift can be suppressed.

It is noted that although the values of the peak current and the bottom current are not especially limited, from the perspective of suppressing emission delay and relaxation oscillation of the light sources, it is preferred that the first current that is continuously supplied is equal to or greater than a threshold current at which the light source (laser) oscillates. In this case, the second current that is supplied in a time-division manner is set at a smaller value than the continuously supplied first current.

Further, the direct current generated by the transistor Q3 is made to have a pulse shape by switching transistor Q1 and transistor Q2. Since in drive circuits D1 to D4 an emitter-coupled circuit is coupled between transistor Q3 and an output terminal, a pulse-shaped current can be obtained by alternating flowing to transistor Q1 and transistor Q2 a current value determined based on transistor Q3 (the same value as the above-described direct current).

The switching operation between the transistors Q1 and Q2 can be realized by causing the transistors to have a potential difference between their respective base terminals. For example, the transistors Q1 and Q2 can be switched and controlled by a pulse signal source (a timing generator) via an HF amplifier. Further, the control of the emission timing of each light source is carried out by this timing generator.

Consequently, each of the light sources emittes pulsed light, so that the microparticles 10 are irradiated with a plurality of laser light beams having different wavelengths on in a time-division manner. During this operation, as illustrated in FIG. 7, each of the light sources is constantly on at a very low power output (bias power: e.g., 1 to 2 mW), and is emitting pulsed light at a power output that is sufficiently greater than the bias power (peak power: e.g., 10 mW or more). At this point, it is sufficient for the peak power value to be twice or more the bias power, preferably 10 times or more, and more preferably 50 to 100 times more. Such a value enables crosstalk during fluorescence detection to be reduced.

The scatter light and fluorescence emitted from the microparticles 10 is detected by a photodetector such as a CCD or a PMT, and output as a current signal. This current signal is converted into a voltage signal by a current-to-voltage conversion (I/V) amplifier, and input to a sample hold (S/H) circuit. At this sample hold (S/H) circuit, the signal level during the period that the light source which is exciting the fluorescence to be detected is on is acquired, and the level during the period that the other light sources are on is stored. As a result, the fluorescence signals illustrated in FIG. 9 are obtained.

Further, in the method for detecting microparticles according to the present embodiment, by generating a timing signal at the timing generation circuit 6, the light emission by the light sources and the detection by the photodetectors are synchronized. The timing generation circuit 6 outputs to the light source drive control unit 3 a timing signal that successively and intermittently turns on each light source (refer to FIG. 8). Further, the generation circuit 6 outputs to the fluorescence detection unit 4 a timing signal that lets the detection signal pass through only while a specific light source is on, and during other times stores the signal level, and that takes into consideration the transmission delay time from the light sources turning on until the light reaches the respective photodetector in the detection circuit (refer to FIG. 8).

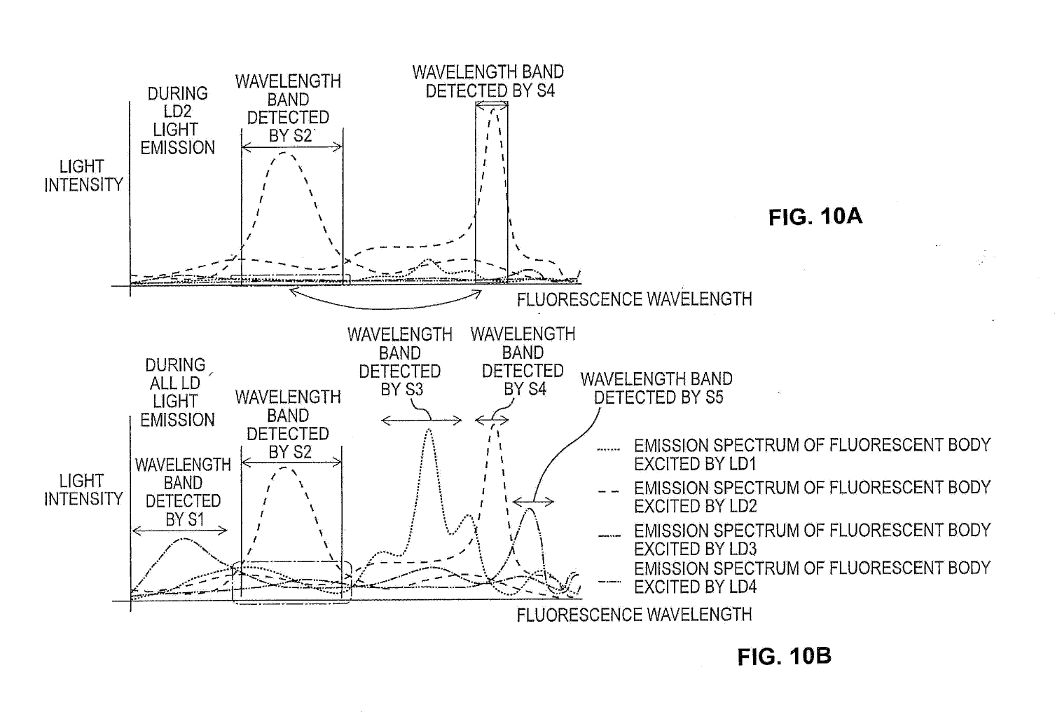

FIG. 10A is a fluorescence spectrum obtained by the microparticle analysis method according to the present embodiment, and FIG. 10B is a fluorescence spectrum obtained by a past method. Regarding the target fluorescence at the detection circuit S2, with the fluorescence spectrum illustrated in FIG. 10B obtained by a past method, the light in the section enclosed by a dashed line is not necessary. However, in a past method that makes all the light sources simultaneously emit light in a coaxial optical system, it is impossible to remove the light in this section even using an optical filter.

In contrast, in the fluorescence spectrum illustrated in FIG. 10A obtained by the method according to the present embodiment, light in the wavelength band detected by the detection circuit S3 and in the wavelength band detected by the detection circuit S5 can be removed. Consequently, with the microparticle analysis apparatus 1 according to the present embodiment, the target fluorescence can be accurately detected by the detection circuit S2.

In the microparticle analysis apparatus 1 according to the present embodiment, since the microparticles are irradiated with a plurality of laser light beams having different wavelengths in a time-division manner, interference among the detected light beams can be suppressed. Further, by irradiation in a time-division manner, the overall amount of light irradiation is reduced, so that the damage on the microparticles and on the plastic microchannels can be reduced.

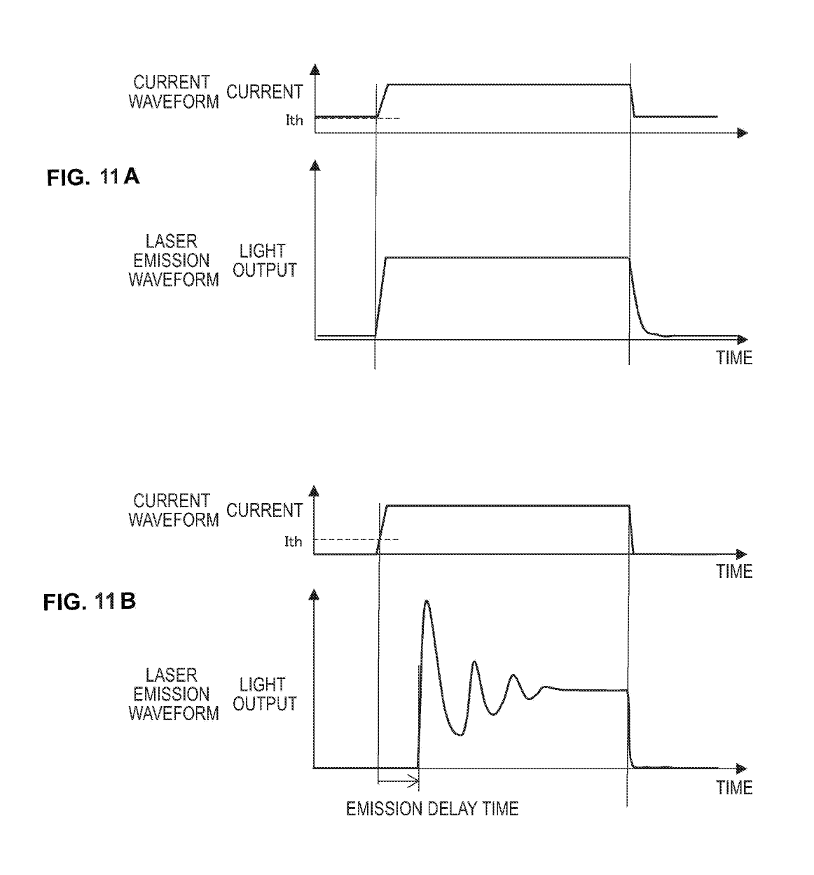

Further, in the microparticle analysis apparatus 1 according to the present embodiment, since the second current for pulse emission is supplied while the first current is being supplied, each light source is in a constantly on state without ever completely turning off like the apparatus described in JP-A-2007-46947. FIG. 11A is a diagram illustrating a laser emission waveform in the microparticle analysis apparatus according to the present embodiment, and FIG. 11B is a diagram illustrating a laser emission waveform in a past apparatus.

As illustrated in FIG. 11B, when light irradiation is performed in a time-division manner with a past apparatus, since the light sources are repeatedly turned on and off, the emission waveform of the laser does not keep its pulse width, and the waveform also distorts. Consequently, such an apparatus is not suited to analysis of microparticles flowing though a channel. In contrast, in the microparticle analysis apparatus 1 according to the present embodiment, since the light sources are not turned off and are in an oscillating state, the pulse width of the current waveform is maintained as is as the pulse width of the emission waveform. This enables various problems caused by relaxation oscillation and emission delay to be resolved, so that the microparticles flowing though the channel can be accurately analyzed.

### 2. Modified Example of the First Embodiment of the Present Disclosure

### Overall Configuration of the Microparticle Analysis Apparatus

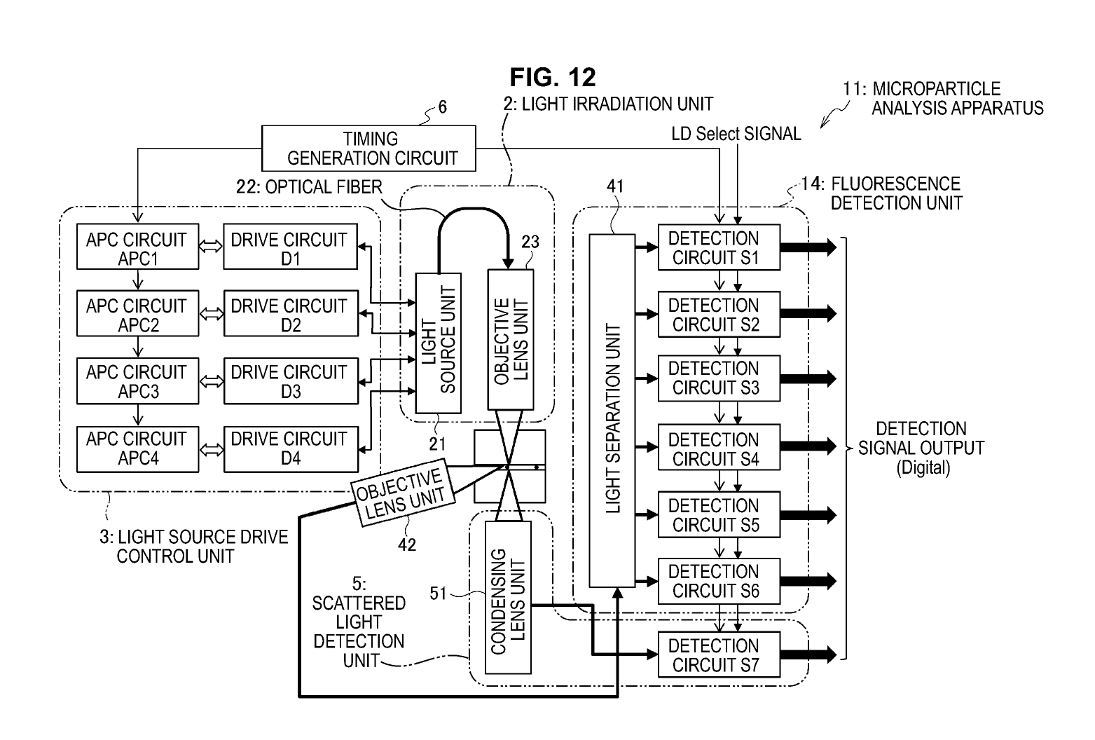

Next, a microparticle analysis apparatus according to a modified example of the first embodiment of the present disclosure will be described. FIG. 12 is a block diagram illustrating a configuration of the microparticle analysis apparatus according to this modified example. In FIG. 12, constituent elements that are the same as those of the microparticle analysis apparatus 1 illustrated in FIG. 1 are denoted with the same reference numerals, and a detailed description thereof will be omitted here.

In the microparticle analysis apparatus 1 illustrated in FIG. 1, fluorescence from the microparticles 10 is condensed by the objective lens unit 23 provided in the light irradiation unit 2. However, in a microparticle analysis apparatus 11 according to this modified example, as illustrated in FIG. 12, a separate objective lens unit 42 is provided in a fluorescence detection unit 14. Further, the fluorescence condensed by the objective lens unit 42 is focused on the light separation unit 41 via an optical fiber and the like.

Based on such a configuration, a side scatter component for detecting the complexity of a cell can be detected. Since a greater amount of side scatter is detected than back scatter, a signal having a higher-quality scatter component can be detected. It is noted that the configuration and advantageous effects of the microparticle analysis apparatus 11 according to this modified example other than those described above are the same as in the above-described first embodiment of the present disclosure.

### 3. Second Embodiment of the Present Disclosure

Next, the microparticle analysis apparatus according to a second embodiment of the present disclosure will be described. As described above, when making each light source emit pulsed light, if the peak power is made sufficiently greater than the bias power, crosstalk in the detected fluorescence can be reduced even if the light irradiation is performed in a time-division manner. However, if the peak power is not large enough, crosstalk in the detected fluorescence can occur. Further, offset can also occur even when not emitting pulsed light due to the light sources emitting light at a low power.

Accordingly, in the microparticle analysis apparatus according to the present embodiment, the effects of crosstalk and offset are suppressed by performing correction at a light detection unit. For example, when a specific light source LDᵢ is emitting light at peak power, the other light sources are emitting light at a low output bias power. Offset occurs due to the light sources other than the light source that is exciting the target fluorescence also emitting light. Therefore, by acquiring the fluorescence signal when the light sources other than light source LDᵢ are on, offset can be corrected.

### (Detection Circuit)

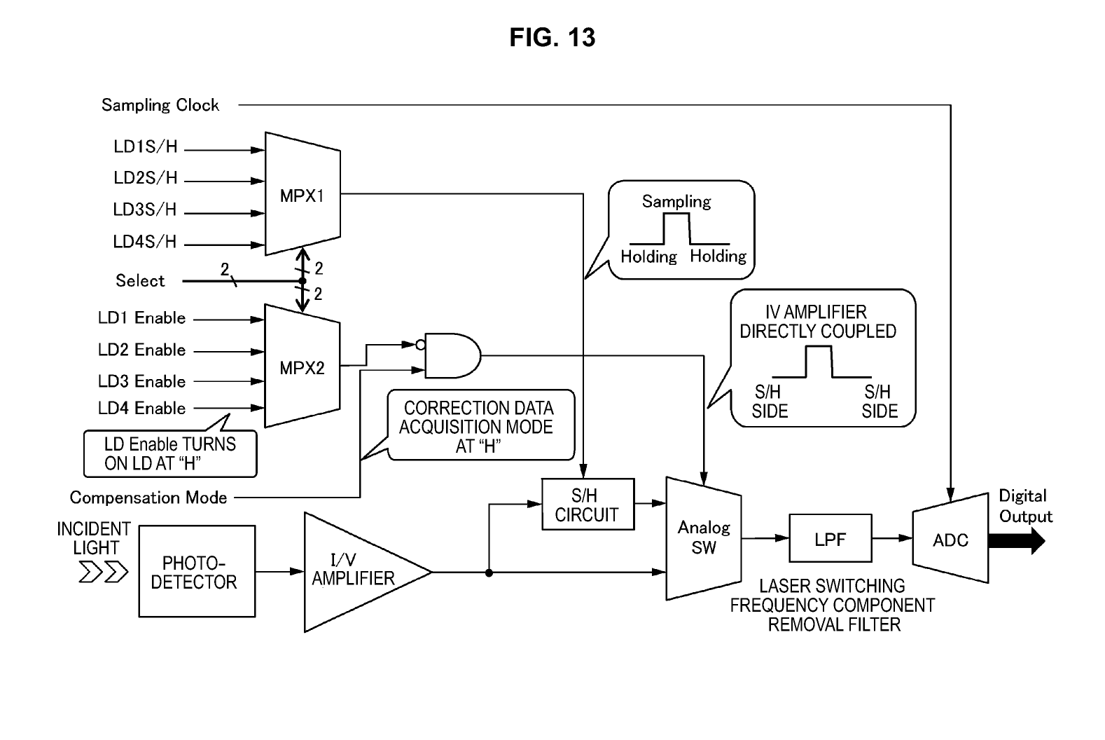

FIG. 13 is a block diagram illustrating a configuration of a detection circuit in the microparticle analysis apparatus according to the present embodiment. As illustrated in FIG. 13, the detection circuit in the microparticle analysis apparatus according to the present embodiment includes a sample hold (S/H) circuit and an analog switch that are connected to a current-to-voltage conversion amplifier. Further, the sample hold (S/H) circuit is also connected to the analog switch, and the analog switch is connected to an analog-digital conversion circuit via a low-pass filter.

Further, a switch (MPX1) for selecting the fluorescence to be detected (the laser to output the excitation light) is connected to the sample hold (S/H) circuit. On the other hand, a switch (MPX2) for selecting the active laser and a correction mode (Compensation Mode) input terminal are connected to the analog switch. Further, the detection circuit is configured to switch between measurement and correction based on which of these two switches (MPX1 and MPX2) is operated.

Specifically, during normal measurement mode, the analog switch selects the sample hold (S/H) circuit side, so that an output from the sample hold (S/H) circuit is transmitted to the low-pass filter (LPF) circuit. On the other hand, during correction mode, the analog switch selects the current-to-voltage conversion (IN) amplifier side, so that an output from the current-to-voltage conversion (IN) amplifier is transmitted to the low-pass filter (LPF) circuit.

### (Operation)

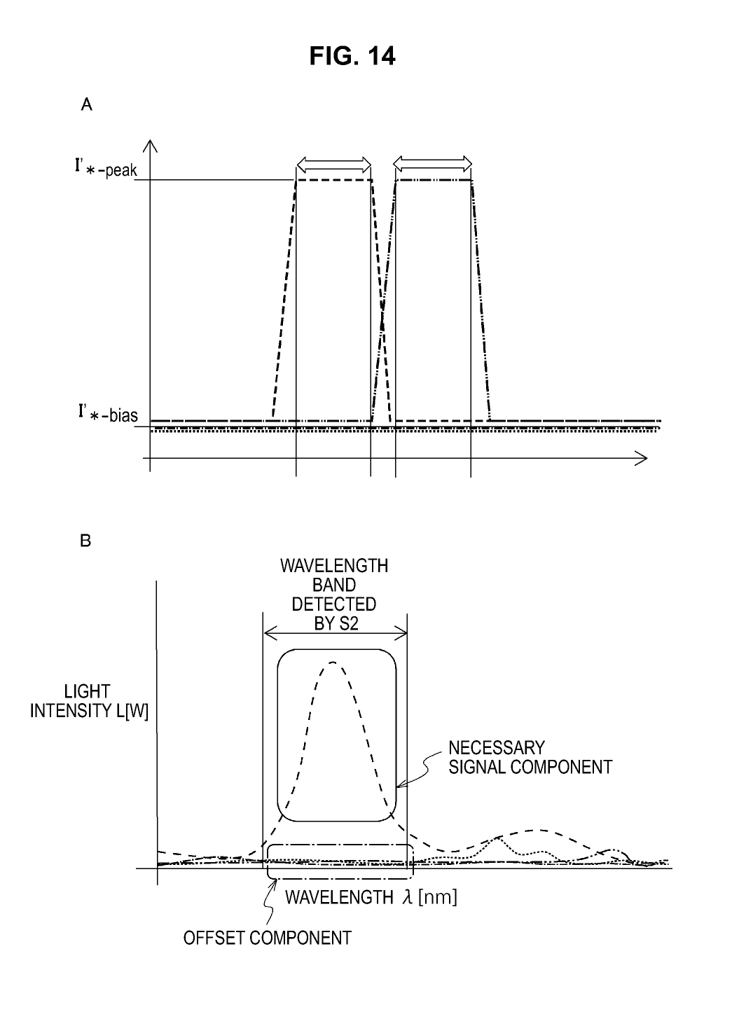

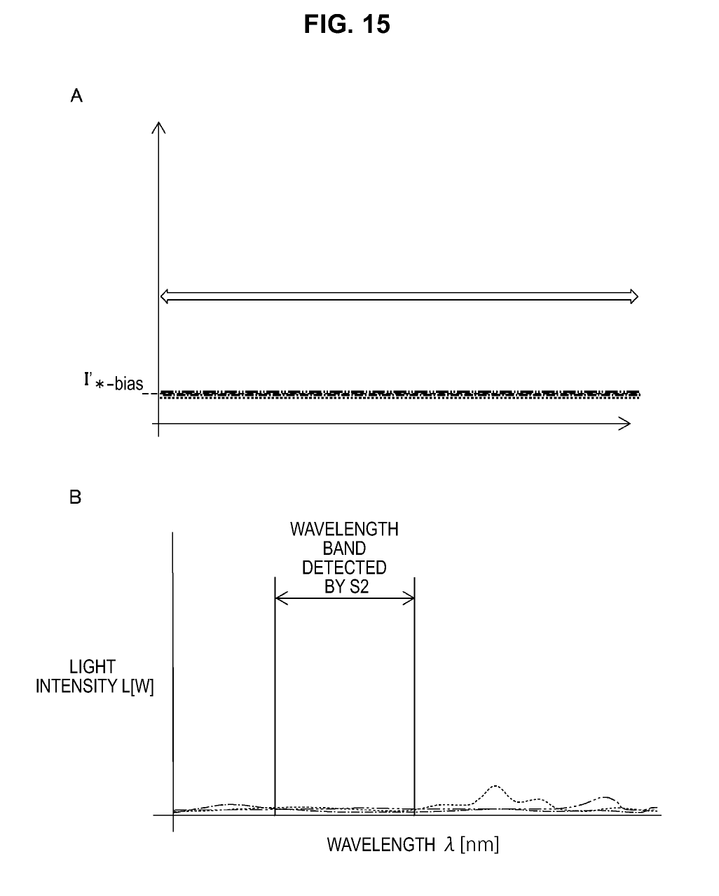

FIG. 14A is a diagram illustrating a light source emission pattern during normal measurement, and FIG. 14B is a fluorescence spectrum at that time. FIG. 15A is a diagram illustrating a light source emission state during correction value acquisition, and FIG. 15B is a fluorescence spectrum at that time. When normal measurement is carried out with the emission pattern illustrated in FIG. 14A, the detected fluorescence spectrum looks like that illustrated in FIG. 14B. Further, when the fluorescence excited by light source LD2 is detected by the photodetector PD2, for example, the composite signal level (I_{total-PD2}) detected by the photodetector PD2 is represented by the following Equation 1.

I_{total(@S2)}=e₁·I_{1-bias}+e₂·I₂₋ₚₑₐₖ+e₃·I_{3-bias}+e₄·I_{4-bias}

It is noted that I₂₋ₚₑₐₖ is the fluorescence excited by the laser light emitted from the light source LD2, and I_{x-bias} is the light resulting from the laser light emitted from the light source LDx. Further, e₁ to e₄ denote the fluorescence conversion efficiency (wavelength mean value) in the transmission wavelength band of the photodetector PD2 of each beam of fluorescence.

Here, the light derived from the light sources other than LD2 is an offset component (refer to FIG. 14B). Therefore, when performing correction, as illustrated in FIG. 15A, detection is carried out by the photodetector PD2 in a state in which only the light source LD2 is extinguished and the other light sources are turned on. Consequently, the spectrum illustrated in FIG. 15B, which represents the offset component, can be obtained. It is noted that the composite signal level (I_{total-PD2}) detected during correction is represented by the following Equation 2.

I′_{total(@S2)}=e₁·I_{1-bias}+e₃·I_{3-bias}+e₄·I_{4-bias}

Further, as shown in the following Equation 3, a signal from which the offset component has been removed, and thus has only the portion that is to be used, can be extracted by determining the difference between the above Equations 1 and 2.

I′_{total(@S2)}−I′_{total(@S2)}=e₂·I₂₋ₚₑₐₖ

Here, when the correction mode (Compensation Mode) is set to “L”, the detection circuit performs normal measurement, and when set to “H”, the detection circuit performs the above-described offset correction. During offset correction, the analog switch is directly coupled to the current-to-voltage conversion amplifier. Further, in this state, data (offset data value) is input and stored in the analog-digital conversion circuit. This operation is successively executed for the other light sources as well. On the other hand, during normal measurement, the analog switch is directly coupled to the sample hold (S/H) circuit, calculation processing is carried out using the above-described offset data value, and the obtained data is corrected. The operation of each light source is shown in the following table. It is noted that when the correction mode (Compensation Mode) is set to “H”, each light source (LD) is turned on.

| Ch of LD used | | | | | | LD Drive Circuit | | | |
|---|---|---|---|---|---|---|---|---|---|
| as excited light | Setting | | | | | LD ON Timing Signal | | | |
| normal light | Compensation | | | | | (representation on Plus polarity) | | | |
| emission | Mode | LD1 Enable | LD2 Enable | LD3 Enable | LD4 Enable | LD1 ON | LD2 ON | LD3 ON | LD4 ON |
| none | L | L | L | L | L | L | L | L | L |
| 4 | L | L | L | L | H | L | L | L | [symbol] |
| 3 | L | L | L | H | L | L | L | [symbol] | L |
| 3, 4 | L | L | L | H | H | L | L | [symbol] | [symbol] |
| 2 | L | L | H | L | L | L | [symbol] | L | L |
| 2, 4 | L | L | H | L | H | L | [symbol] | L | [symbol] |
| 2, 3 | L | L | H | H | L | L | [symbol] | [symbol] | L |
| 2, 3, 4 | L | L | H | H | H | L | [symbol] | [symbol] | [symbol] |
| 1 | L | H | L | L | L | [symbol] | L | L | L |
| 1, 4 | L | H | L | L | H | [symbol] | L | L | [symbol] |
| 1, 3 | L | H | L | H | L | [symbol] | L | [symbol] | L |
| 1, 3, 4 | L | H | L | H | H | [symbol] | L | [symbol] | [symbol] |
| 1, 2 | L | H | H | L | L | [symbol] | [symbol] | L | L |
| 1, 2, 4 | L | H | H | L | H | [symbol] | [symbol] | L | [symbol] |
| 1, 2, 3 | L | H | H | H | L | [symbol] | [symbol] | [symbol] | L |
| 1, 2, 3, 4 | L | H | H | H | H | [symbol] | [symbol] | [symbol] | [symbol] |
| none | H | L | L | L | L | L | L | L | L |
| 1 | H | L | H | H | H | L | H | H | H |
| 2 | H | H | L | H | H | H | L | H | H |
| 3 | H | H | H | L | H | H | H | L | H |
| 4 | H | H | H | H | L | H | H | H | L |

Since the microparticle analysis apparatus according to the present embodiment includes an offset function, fluorescence detection accuracy can be improved even further. It is noted that the configuration and advantageous effects of the above-described microparticle analysis apparatus according to present embodiment other than those described above are the same as in the above-described first embodiment of the present disclosure.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)
A microparticle analysis apparatus including:

a light irradiation unit, which includes a plurality of light sources that emit laser light beams having different wavelengths, and which is configured to irradiate, with the laser light, microparticles flowing through a channel; and

a light source drive control unit configured to control light emission by each light source in the light irradiation unit,

wherein the light source drive control unit is configured to supply a first current to each light source, and to supply in a time-division manner a second current to each light source while the first current is being supplied.

(2)
The microparticle analysis apparatus according to (1), wherein the first current is greater than the second current.
(3)
The microparticle analysis apparatus according to (1) or (2), wherein the light source drive control unit includes, for each light source, a first current control unit configured to control supply of the first current and a second current control unit configured to control supply of the second current.
(4)
The microparticle analysis apparatus according to any one of (1) to (3), wherein the light source drive control unit includes, for each light source, an auto power control circuit and a drive circuit.
(5)
The microparticle analysis apparatus according to any one of (1) to (4), further including:

a light detection unit configured to detect light emitted from microparticles irradiated with the laser light,

wherein the light detection unit includes at least

a light separation optical system configured to separate light emitted from the microparticles according to wavelength, and

a plurality of photodetectors configured to detect light separated by the light separation optical system.

(6)
The microparticle analysis apparatus according to (5), wherein the light detection unit includes, for each photodetector, a detection circuit configured to control acquisition of a detection signal.
(7)
The microparticle analysis apparatus according to (6), wherein the detection circuit includes a switch configured to switch between a correction mode and a measurement mode.
(8)
The microparticle analysis apparatus according to (6) or (7), further including:

a plurality of auto power control circuits provided in the light source drive control unit; and

a timing generation circuit configured to output a timing signal to a plurality of detection circuits provided in the light detection unit.

(9)
A microparticle analysis method including:

emitting laser light beams having different wavelengths from each other from a plurality of light sources; and

irradiating, with each laser light beam, microparticles flowing through a channel,

wherein the microparticles are irradiated with the plurality of laser light beams having different wavelengths in a time division manner by supplying a first current to each light source, and supplying in a time-division manner a second current to each light source while the first current is being supplied.

(10)
The microparticle analysis method according to (9), wherein the first current is set to be greater than the second current.
(11)
The microparticle analysis method according to (9) or (10), wherein supply of the first current and supply of the second current are controlled individually and independently.
(12)
The microparticle analysis method according to any one of (9) to (11), further including:

separating the light emitted from the microparticles irradiated with laser light according to wavelength; and

detecting the light separated in the light separation step with a plurality of photodetectors.

(13)
The microparticle analysis method according to (12), wherein emission by the light sources and detection by the photodetectors are performed in synchronization.
(14)
The microparticle analysis method according to (12) or (13), wherein fluorescence data detected in the detection step is corrected based on offset data detected in advance.

What is claimed is:

1. A microparticle analysis apparatus comprising:
a light irradiation unit, which includes a plurality of light sources that emit laser light beams having different wavelengths, and which is configured to irradiate, with the laser light, microparticles flowing through a channel; and
a light source drive control unit configured to control light emission by each light source in the light irradiation unit,
wherein the light source drive control unit is configured to supply a first current to each light source, and to supply in a time-division manner a second current to each light source while the first current is being supplied.

2. The microparticle analysis apparatus according to claim 1, wherein the first current is greater than the second current.

3. The microparticle analysis apparatus according to claim 1, wherein the light source drive control unit includes, for each light source, a first current control unit configured to control supply of the first current and a second current control unit configured to control supply of the second current.

4. The microparticle analysis apparatus according to claim 1, wherein the light source drive control unit includes, for each light source, an auto power control circuit and a drive circuit.

5. The microparticle analysis apparatus according to claim 1, further comprising:
a light detection unit configured to detect light emitted from microparticles irradiated with the laser light,
wherein the light detection unit includes at least
a light separation optical system configured to separate light emitted from the microparticles according to wavelength, and
a plurality of photodetectors configured to detect light separated by the light separation optical system.

6. The microparticle analysis apparatus according to claim 5, wherein the light detection unit includes, for each photodetector, a detection circuit configured to control acquisition of a detection signal.

7. The microparticle analysis apparatus according to claim 6, wherein the detection circuit includes a switch configured to switch between a correction mode and a measurement mode.

8. The microparticle analysis apparatus according to claim 5, further comprising:
a plurality of auto power control circuits provided in the light source drive control unit; and
a timing generation circuit configured to output a timing signal to a plurality of detection circuits provided in the light detection unit.

9. A microparticle analysis method comprising:
emitting laser light beams having different wavelengths from each other from a plurality of light sources; and
irradiating, with each laser light beam, microparticles flowing through a channel,
wherein the microparticles are irradiated with the plurality of laser light beams having different wavelengths in a time division manner by supplying a first current to each light source, and supplying in a time-division manner a second current to each light source while the first current is being supplied.

10. The microparticle analysis method according to claim 9, wherein the first current is set to be greater than the second current.

11. The microparticle analysis method according to claim 9, wherein supply of the first current and supply of the second current are controlled individually and independently.

12. The microparticle analysis method according to claim 9, further comprising:
separating the light emitted from the microparticles irradiated with laser light according to wavelength; and
detecting the light separated in the light separation step with a plurality of photodetectors.

13. The microparticle analysis method according to claim 12, wherein emission by the light sources and detection by the photodetectors are performed in synchronization.

14. The microparticle analysis method according to claim 12, wherein fluorescence data detected in the detection step is corrected based on offset data detected in advance.
